(19) United States
(12) Patent Application Publication
(10) Pub. No.: US 2007/0185268 A1
(43) Pub. Date: Aug. 9, 2007

(54) POLYBUTADIENE COMPOSITIONS, METHODS, AND ARTICLES

(75) Inventors: Steven K. Henning, Downingtown, PA (US); Jeffrey Klang, West Chester, PA (US); Richard Costin, West Chester, PA (US)

Correspondence Address: COZEN O'CONNOR, P.C., 1900 MARKET STREET, PHILADELPHIA, PA, 19103-3508, US

(73) Assignee: SARTOMER TECHNOLOGY COMPANY, INC., Wilmington, DE (US)

(21) Appl. No.: 11/673,081

(22) Filed: Feb. 9, 2007

Related U.S. Application Data
(60) Provisional application No. 60/771,913, filed on Feb. 9, 2006.

(51) Int. Cl. C08F 8/00

(52) U.S. Cl. 525/192

(57) ABSTRACT

Terminally-functional low molecular weight alkoxylated polybutadiene (meth)acrylates are used to improve the physical properties of elastomeric compositions cured in the presence of at least one free-radical generating compound selected from peroxides, percarbonates or azo compounds. The elastomers are natural or synthetic, or mixtures thereof. Reinforcing fillers may also be present. Preferred alkoxylated polybutadiene (meth)acrylates are of Formula I

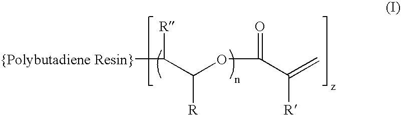

wherein R is H, Me, Et or C₆H₅; R″ is H or Me; R″ is H or Me; n=1 to 100; and Z=1 to 3.

### CROSS-REFERENCE TO RELATED APPLICATIONS

Benefit of provisional application 60/771,993 filed Feb. 09, 2006 is claimed.

### BACKGROUND OF THE INVENTION

This invention relates generally to improved elastomeric compositions useful for forming vulcanized rubber, methods for making such vulcanized rubber, and vulcanized rubber articles.

Elastomeric compositions must be vulcanized to provide useful rubber properties. Vulcanization reactions result in chemical crosslinks between proximal polymer chains. By crosslinking elastomeric polymers, useful materials can be formed which possess physical properties such as high tensile strengths, low compression set, recoverable elongations, high modulus, and improved dynamic performances.

Peroxides are capable of vulcanizing most elastomeric polymer types, including unsaturated and saturated elastomers. Coagents are radical-accepting compounds which increase the efficiency of crosslink formation. Coagents are typically monomeric in structure and contain at least two radical accepting reactive sites. The use of coagents synergistically with peroxides helps expand the utility of this vulcanization process.

Synergistic use of multifunctional coagents can improve the efficiency of peroxide cure by increasing the crosslink density of the network and by altering the crosslink composition. There are many functional compounds that have been used as coagents for peroxide cure. The final properties of the formed network will depend on the reactivity and structure of the coagent.

Typically, the choice of coagent is made in order to balance several desired physical properties of the resulting vulcanizate. Often, the use of acrylate-containing coagents increases the rate of vulcanization and can result in compositions which tend to crosslink prematurely or possess little scorch safety. This problem has been mediated through the judicious introduction of scorch-retarding additives to the coagent, rubber composition, or peroxide itself. In this way, the onset of vulcanization can be delayed so that sufficient process safety is imparted to the rubber composition. The use of coagents currently available often results in a trade-off between maintaining scorch safety and improving final physical properties. For example, common multifunctional acrylates can improve the modulus and tensile strength of peroxide-cured elastomeric compositions, but at reduced scorch safety. Low molecular weight vinyl-containing polybutadienes are also used as coagents for peroxide cure. Using such materials maintains the scorch safety of the compound, but does not achieve the modulus or tensile strength of compounds that employ acrylate or other more reactive coagents.

In addition, multifunctional acrylates typically provide optimal performance at relatively low loadings, and any gain in physical properties is eroded at higher loadings, probably due to limited solubility of multifunctional acrylates in most rubber compositions.

Therefore there exists a need for a multifunctional acrylate coagent that can provide improvements in the physical properties of peroxide-cured rubber compositions while maintaining the scorch safety. There is also a need to increase the loadings at which the multifunctional acrylate produced the greatest positive impact on the physical properties of the rubber compound.

There have been several different prior art proposals concerning the use of acrylate-containing coagents to improve physical properties while mediating the impact of such additives on the scorch safety of the compound.

The prior art does not teach or suggest the use of a low molecular weight terminally-functional polybutadiene acrylate to impart both improved physical properties and scorch safety to peroxide-curable elastomeric compositions.

### SUMMARY OF THE INVENTION

The present invention comprises in one aspect a method for making elastomeric compositions, the compositions themselves, and articles cured therefrom. The elastomeric compositions of the invention comprise one or more natural or synthetic elastomers, and one or more terminally-functional alkoxylated polybutadiene (meth)acrylates. The compositions optionally include up to 200 parts of a filler material preferably comprises a free-radical source capable of initiating crosslinking reactions. The terminally functional alkoxylated polybutadiene (meth)acrylates preferably have high vinyl content which allows them to act as effective coagents. The compositions and articles of the invention possess both extended scorch safety and improved physical properties without the use of additional retarding compounds whose purpose is to scavenge free radicals and delay vulcanization. The compositions and articles have increased cured tensile strength and modulus at equivalent loadings of conventional monomeric multifunctional acrylates. The elastomeric compositions and articles of the invention can be used in applications including, but not limited to, tire components, engineered rubber products such as belts and hoses, rubber gaskets and rings, engine mounts and vibration isolation mounts, rubber rollers, and rubber articles for other automotive and industrial applications.

The method aspect of the invention comprises adding from 1 to 40 parts of one or more coagents comprising one or more terminally-functional polybutadiene (meth)acrylates and a free radical generating compound to 100 parts by weight of one or more elastomers and then vulcanizing in the presence of the free radical generating compound.

The article aspect of the invention comprises vulcanized rubber articles prepared by vulcanizing the composition of the invention. Examples of types of articles are, for example, tire components, rubber articles for automotive and industrial applications, and engineered rubber products selected from belts, hoses, rubber gaskets, rings, engine mounts, vibration isolation mounts, and rubber rollers.

### DETAILED DESCRIPTION

The preferred elastomeric compositions of the invention comprise one or more natural or synthetic elastomers, and one or more terminally-functional alkoxylated polybutadiene(meth)acrylates. In preferred embodiments, based on 100 parts by weight of elastomers, the terminally-functional alkoxylated polybutadiene(meth)acrylates comprise 1 to 40 parts by weight and optional filler, when present, comprises up to 200 parts by weight.

Preferred alkoxylated polybutadiene(meth)acrylates are of Formula I

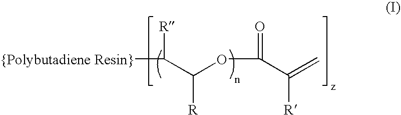

wherein
R is H, Me, Et or C₆H₅,
R′ is H or Me,
R″ is H or Me,
n=1 to 100, and
Z=1 to 3.

The one or more terminally functional alkoxylated polybutadiene(meth)acrylates act as coagents and function to improve the physical properties of rubber compositions while simultaneously providing increased scorch safety when compared to other typical monomeric multifunctional acrylate coagents.

Preferably the rubber compositions are curable through the action of one or more free radical generating compounds, for example peroxides, percarbonates or azo compounds. The term “(meth)acrylates” is used herein as meaning “acrylates and/or methacrylates.”

Preferred polymers of Formula I have one alkoxy (n=1), preferably one ethoxy or propoxy and more preferably one propoxy unit, at each end of a difunctional polybutadiene (Z=2) and contain terminal (meth)acrylate functionality.

The invention comprises compositions comprising by weight 100 parts of one or more elastomers; and about 1 to 40 parts of one or more terminally-functional alkoxylated polybutadiene(meth)acrylates of Formula I as coagents. These compositions are curable in the presence of free-radical generating compound such as peroxides, percarbonates or azo compounds.

The invention also comprises a method of preparing the compositions comprising adding the one or more coagents to 100 parts of the one or more elastomers and vulcanizing in the presence of a free radical generating compound and vulcanized rubber articles prepared according to the method.

The vulcanized articles of the invention can be in any form, for example in the form of a tire component, a rubber article for automotive and industrial applications, and an engineered rubber product selected from the group consisting of belts, hoses, rubber gaskets, rings, engine mounts, vibration isolation mounts, and rubber rollers.

The compositions of the invention preferably comprise by weight 100 parts of an elastomer or blend of elastomers; from 1 to 40, preferably from 5 to 20 parts by weight, of a coagent comprising at least one terminally-functional alkoxylated polybutadiene acrylate and/or methacrylate; and optionally, up to 200 parts, preferably up to 150 parts, and more preferably about 50 to 100 parts, of a filler material. Many embodiments of the compositions of the invention do comprise one or more fillers.

The said terminally-functional polybutadiene acrylates are produced from alkoxylated polybutadiene diols of corresponding number average molecular weight Mn of 1000 to 12,000 g/mol and they can contain only 1/10th of the amount of active (meth)acrylate functionality when compared to conventional (meth)acrylated monomeric coagents at equivalent phr loadings. They yet increase crosslink density and provide improved physical properties versus the conventional coagents. Scorch inhibiting additives are not required; however, in some cases they may provide additional scorch protection. The said terminally-functional alkoxylated polybutadiene acrylates are included in an amount from about 0.1 to about 40 parts by weight, preferably from about 5 to about 20 parts by weight, per hundred parts by weight of the elastomer(s) employed.

The alkoxylated polybutadiene acrylates of the invention can be formed by transesterification, direct esterification or by reaction with acrylic and/or methacrylic halides or anhydrides. Transesterification and direct esterification are the preferred industrial methods. More particularly in the case of transesterification, the process of preparing the final polymer of the invention comprises a transesterification reaction between the corresponding hydroxyl terminated alkoxylated polybutadiene resin, preferably the corresponding diol and a low molecular weight acrylate and/or methacrylate ester, which can be preferably selected from: methyl acrylate, ethyl acrylate, n-butyl or isobutyl or tertiobutyl acrylate, methyl methacrylate, ethyl methacrylate, n-butyl or isobutyl or tertiobutyl methacrylate. In such a case the transesterification reaction is preferably catalyzed by at least a catalyst selected from: metal alkoxides, metal oxides, Lewis acids or other catalysts or combinations, known in the art to catalyze transesterification reactions. Molecular weights in the range of 500 to 10,000 Daltons are preferred. For polybutadiene resins, microstructure refers to the amounts 1,2- vs. 1,4-addition and the ratio of cis to trans double bonds in the 1,4-addition portion. The amount of 1,2-addition is often referred to as vinyl content. The vinyl content of the polybutadiene can range from about 5% to about 90%. The ratio of cis to trans double bonds can range from about 1:10 to about 10:1. The average number of reactive terminal hydroxyl groups per molecule can range from about 1 to 3. A preferred range is from about 1.0 to 2.0 and more preferably 2.0. The alkoxylated terminally functional polybutadiene (meth)acrylates of Formula I are described in Klang, et al., U.S. Ser. No. 10/938,221, which is hereby incorporated by reference.

A second option in preparing the acrylate terminated alkoxylated polybutadienes of Formula I is direct esterification of the corresponding hydroxyl terminated alkoxylated polybutadiene with acrylic and/or methacrylic acid, halide or anhydride. In direct esterification with acrylic and/or methacrylic acid, esterification catalysts can be used selected from sulfuric acid, p-toluenesulfonic acid methanesulfonic acid, or other strong mineral or organic acids known in the art to catalyze esterification reactions. The said hydroxyl-terminated polybutadiene resins are preferably obtained by anionic polymerization of butadiene.

It is also possible that the said polybutadiene hydroxyl-terminated resin is an anionic copolymer of butadiene with other anionically polymerizable dienes and/or comonomers such as (but not limited to): isoprene or vinyl aromatic monomers such as styrene. The said copolymers may be random or block copolymers, the block copolymers being preferably diblock copolymers. As examples of such random or block copolymers may be cited styrene-butadiene or styrene-isoprene copolymers.

More particularly the said alkoxylated polybutadiene acrylate bears terminal acrylate ester groups and preferably is a difunctional one (diacrylate). More preferably the said polybutadiene contains at least 50% vinyl microstructure (at least 50% of the total unsaturation).

The said elastomer or blend of elastomers according to the present invention can be selected from the group of polydienes, copolymers of dienes and vinyl aromatic monomers, copolymers of dienes and acrylonitrile monomer, copolymers of ethylene and propylene, terpolymers of ethylene, propylene, and diene-containing monomers, hydrogenated forms of copolymers of dienes and acrylonitrile monomer, and hydrogenated forms of terpolymers of dienes, acrylonitrile monomers, and carboxylated monomers.

The elastomers with which the said terminally-functional polybutadiene acrylates may be utilized in accordance with the present invention include, without limitation, the elastomeric organic high polymers, including natural rubber and the various synthetic rubbers or rubbery polymers (the term “polymers” including “copolymers”) which cure with a free radical generating compound or radiation source. In general, these curable rubbers are polymers of conjugated dienes or polymers with easily abstractable hydrogen wherein the monomers are linked through carbon-carbon bonds. Illustrative synthetic rubbery polymers of conjugated dienes include, without limitation: synthetic polyisoprene, styrene-butadiene rubbers, polybutadiene rubbers, butyl rubber, bromobutyl rubber, chlorobutyl rubber, the neoprenes, ethylene propylene rubbers, nitrile elastomers, silicone elastomers, thermoplastic elastomers, fluoroelastomers, high styrene butadiene copolymers, vinyl acetate ethylene copolymers, chlorinated polyethylene rubber, chlorosulfonated polyethylene elastomer, polyethylene and reclaimed rubber.

The term “peroxide-curable” according to the present invention, except if otherwise specified, should be considered as meaning curable by means of vulcanizing agents or compounds which are able to thermally decompose and to generate free radicals which can initiate the cure or vulcanization of the said rubber composition. Vulcanizing agents that decompose to generate free radicals during the curing cycle may be employed as curing agents to cure the elastomers in the compositions and methods of the present invention. Suitable free radical generating compounds include, without limitation, peroxides, percarbonates, azo compounds and the like.

Ditertiary peroxide curing compounds are the preferred free radical generating compounds. These ditertiary peroxide curing agents contain at least one peroxy group disposed between tertiary carbon atoms, which tertiary carbon atoms are linked to carbon atoms constituting portions of each of the appended groups, which appended groups may be alkyl (including straight, branched or cyclic), alkenyl, or aryl groups, or mixtures of such groups, and which appended groups may be further substituted by non-hydrocarbon groups, for example, ethers, additional peroxy groups, or halogens, such as chlorine, which inorganic peroxides do not interfere with either the curing process or the cured elastomeric product.

Illustrative organic peroxides in accordance with the above description include: di-t-butyl peroxide, dicumyl peroxide, 2,5-bis(t-butylperoxy)-2,5-dimethyl-hexane, α,α′-bis-(t-butylperoxy)diisopropyl benzene, t-butylcumyl peroxide, and 2,5-dimethyl-2,5-di(t-butylperoxy)hexyne-3.

Suitable organic peroxides may also include, without limitation, acyl peroxides, peroxy ketals, peroxy esters, and peroxy carbonates. Examples of such peroxides include, without limitation, dibenzoyl peroxide, di-(p-chloro-benzoyl)peroxide, di-(2,4-dichlorobenzoyl)peroxide, methyl ethyl ketone peroxide, cyclohexanone peroxide, t-butyl peroxide, t-butyl peroxy(2-ethylhexanoate), t-butylperoxyisobutyrate, O,O-t-butyl-O-isopropylmonoperoxy-carbonate, t-butylperoxy pivalate, dimethyl-di(benzoylperoxy)hexane, t-butyl-peroxy(2-ethylbutyrate), 1,1-di-t-butyl peroxy-3,3,5-trimethylcyclohexane, and n-butyl-bis(t-butylperoxy)-valerate, t-butylperoxy benzoate, 1,1-di(t-butylperoxy)cyclohexane, 4-methyl-4-butylperoxy-2-pentanone, ethyl 3,3-di(t-butylperoxy) butyrate, O,O-t-butyl O-(2-ethylhexyl)monoperoxy carbonate and the like. The foregoing organic peroxides may be used alone or in combination and are commercially available.

The amount of free radical generating compound used in the present invention may be varied depending on the elastomer and coagent selected. Hence, the required amount of free radical generating compound required to practice the present invention is a cure-effective amount readily ascertainable by one of ordinary skill in the art. Generally, an amount from about 0.1 to about 20 parts by weight, preferably from about 0.5 to about 10 parts by weight, per hundred parts by weight of the elastomer or blend of elastomers employed.

Inert fillers may be included in the methods and curable compositions of the invention. If an inert filler is desired, any known or conventional filler which does not interfere with the vulcanization process described herein may be used, and such fillers are desirable in finely divided form. Suitable fillers include, but are not limited to, the following: silica and silicates, thermal blacks (i.e., furnace, channel or lamp carbon black), clays, kaolin, diatomaceous earth, zinc oxide, cork, titania, cotton floc, cellulose floc, leather fiber, elastic fiber, plastic flour, leather flour, fibrous fillers such as glass and synthetic fibers, metal oxides and carbonates and talc. The amount of inert filler is dictated by its type and the intended end use of the composition and, in general, is from 0 to 200, preferably between 0 and 150 and, more preferably, between 50 and 100 parts by weight for 100 parts by weight of the elastomer or of the blend of elastomers.

Other additives which may be added to the curable composition of the present invention, depending upon the intended end-use of the cured elastomer, include antioxidants, UV stabilizers, antiozonants, plasticizers, mold release agents, tackifiers, anti-tack agents, dispersants, solvents, softening agents, fatty acids, processing aids, coloring agents and the like.

The second subject of the invention relates to a method of making a peroxide-curable (vulcanizable) rubber composition as defined according to the invention, comprising adding from 1 to 40 parts of a coagent comprising at least one terminally-functional polybutadiene acrylate and/or methacrylate, and a peroxide as free radical generating curing agent, to 100 parts of a peroxide-curable rubber elastomer or blend of elastomers.

More particularly such a rubber article may be selected from the group of: tire components, rubber articles for automotive and industrial applications, engineered rubber products selected from belts (including transmission belts and transport belts), hoses, rubber gaskets, rings, engine mounts, vibration isolation mounts, and rubber rollers.

The aforementioned ingredients are mixed by any conventional means. Mixing may be accomplished by charging the ingredients to a Banbury mixer or a rubber mixing mill and intimately mixing the ingredients until the composition is uniform. The temperature of the mixing operation is not critical, but should be below temperatures at which the curing reaction commences. Generally, normal rubber milling practice is employed.

To obtain a vulcanized rubber from the said peroxide-curable rubber composition, the required curing times, in general, range from about 1 to 30 minutes and preferably from about 5 to 15 minutes, at a suitable cure temperature range. Cure temperatures should be sufficient thermally to decompose the free-radical generating compound. Thus, the selection of the cure temperature will be predicated mainly upon the free radical generating compound that is selected. The temperatures useful in the present invention may vary between wide limits such as from 90° C. to 250° C. and preferably from 140° C. to about 215° C. For curing large rubber rolls, cure times of 24 hours are common to avoid stressing the roll.

Another aspect of the invention is a vulcanized (cured) rubber article which results from the curing (vulcanization) of at least one peroxide-curable rubber composition as defined according to the invention.

The invention will be clarified further by a consideration of the following examples, which are intended to be purely exemplary.

### EXAMPLES

The following examples, in which all parts and percentages are by weight based on parts per hundred rubber (phr) unless otherwise indicated, are presented to illustrate a few embodiments of the invention and comparisons with other compositions.

The compounded stock originates as a masterbatch containing elastomer, filler, zinc oxide, stearic acid and process oil. A terpolymer of ethylene propylene diene monomer (EPDM) comprised of 55% ethylene and 4.9% 5-ethylidene-2-norbornene by weight with a Mooney viscosity of 40 (ASTM D 1646), was used in addition to a semi-reinforcing carbon black (N660) at 100 phr. Fifty phr of paraffinic oil with a viscosity of 33 centistokes at 100° C. (ASTM D 445), a pour point of −12° C. (ASTM D 97), and an aniline point of 129° C. (ASTM D 611) was used as a process aid. The rubber chemicals zinc oxide and stearic acid were also mixed at 5 and 1 phr, respectively. One phr of 2,2,4-trimethyl-1,2-dihydroquinoline (polymerized) was used as antioxidant. This stock was prepared in a quantity sufficient to use for all evaluations contained in the Examples. The invention is demonstrated by adding to the masterbatch subsequent curatives on a two roll mill. After addition of 7.5 phr of dicumyl peroxide carried on kaolin clay (40% actives) and coagent, the productive compound was masticated on unheated rolls for a minimum of 10 minutes at a roller rpm differential of the ratio 1.3 to 1.0. The compound was then sheeted off the mill and held in preparation for testing.

Cure rheometry was performed on a moving die rheometer (MDR) according to ASTM D 5289. Cured vulcanizates were formed by compression molding at 160° C. for 35 minutes at an arc degree deflection of 3°. State of cure is given as delta torque (M_{H}-M_{L}) as reported from the MDR. Scorch safety was characterized by the time to a two point rise in torque (ts2). Tensile testing was performed according to ASTM D 412 on a tensile tester. Compression set was evaluated after heating at 100° C. for 22 hours (ASTM D 395-B).

The terminally-functional alkoxylated polybutadiene (meth)acrylate was prepared in accordance to the procedure outlined below. A 1 liter multi-neck round bottom flask fitted with a mechanical agitator, thermocouple, air sparge tube and Dean-Stark trap was charged with heptane (157 g), acrylic acid (43 g), methanesulfonic acid (3.2 g), hydroquinone monomethyl ether (1.9 g) and a hydroxyl terminated polybutadiene resin (424 g), with hydroxyl groups derived from ethylene oxide (degree of alkoxylation=2) (2 ethylene oxide units per hydroxyl), having hydroxyl number of 50 mg KOH/g and a calculated number average molecular weight Mn of 2244 g/mol. The mixture was heated to reflux to remove water of reaction and reflux was maintained until water production stopped. After removal of the strong acid catalyst, solvent and excess acrylic the final product was obtained as a viscous light brown liquid. The coagent is a terminally functional alkoxylated polybutadiene diacrylate.

Comparative coagent materials are included in Table 1.

TABLE 1

| Chemical | Acrylate | Vinyl Content | Molecular |
|---|---|---|---|
| Description | Functionality | (Polymer) (%) | Weight (g/mol) |
| 1,4-Butanediol | 2 | — | 198 |
| Diacrylate | | | |
| Trimethylolpropane | 3 | — | 296 |
| Triacrylate | | | |
| Poly(butadiene) | 0 | 65 | 3000 |
| Poly(butadiene) | 0 | 65 | 2000 |

### Examples 1-6

Example 1 (control) was prepared by mixing 7.5 phr of peroxide alone to the masterbatch outlined in Table 2. Examples 2-6, representing the invention, were prepared by adding increasing loadings of terminally-functional polybutadiene diacrylate coagent to the masterbatch in addition to the peroxide. Cure kinetics and physical properties are reported which demonstrate that the addition of the functional polymeric coagent improves the state of cure leading to an increase in tensile strength and modulus while lowering compression set.

TABLE 2

| | Examples | | | | | |
|---|---|---|---|---|---|---|
| Ingredient (phr) | 1 | 2 | 3 | 4 | 5 | 6 |
| EPDM | 100 | 100 | 100 | 100 | 100 | 100 |
| Carbon Black | 100 | 100 | 100 | 100 | 100 | 100 |
| Paraffinic Oil | 50 | 50 | 50 | 50 | 50 | 50 |
| Zinc Oxide | 5 | 5 | 5 | 5 | 5 | 5 |
| Stearic Acid | 1 | 1 | 1 | 1 | 1 | 1 |
| Antioxidant | 1 | 1 | 1 | 1 | 1 | 1 |
| Polybutadiene | | 2 | 5 | 10 | 15 | 20 |
| Diacrylate | | | | | | |
| Dicumyl | 7.5 | 7.5 | 7.5 | 7.5 | 7.5 | 7.5 |
| peroxide | | | | | | |
| Delta Torque | 17.9 | 24.8 | 28.0 | 29.7 | 29.1 | 27.5 |
| (dNm) | | | | | | |
| Scorch Time | 1.48 | 1.10 | 0.94 | 0.93 | 1.08 | 0.99 |
| (minutes) | | | | | | |
| Tensile | 10.15 | 12.15 | 12.62 | 12.28 | 12.22 | 11.76 |
| Strength (MPa) | | | | | | |
| 100% Modulus | 1.74 | 2.43 | 2.65 | 3.07 | 3.67 | 4.07 |
| (MPa) | | | | | | |
| Compression | 24.0 | 15.3 | 12.6 | 11.4 | 11.5 | 9.9 |
| Set (%) | | | | | | |

### Examples 7-12 Comparative

The comparative examples 7-12 given in Table 3 utilize the monomeric coagent 1,4-butanediol diacrylate. The compounds were prepared in a similar manner as outlined in the previous examples. At identical loadings, the monomeric diacrylate displays similar delta torque and tensile properties as the invention Examples 2-6, but increased compression set. In addition, scorch safety is markedly reduced using the monomeric diacrylate.

TABLE 3

| | Examples | | | | | |
|---|---|---|---|---|---|---|
| Ingredient (phr) | 7 | 8 | 9 | 10 | 11 | 12 |
| EPDM | 100 | 100 | 100 | 100 | 100 | 100 |
| Carbon Black | 100 | 100 | 100 | 100 | 100 | 100 |
| Paraffinic Oil | 50 | 50 | 50 | 50 | 50 | 50 |
| Zinc Oxide | 5 | 5 | 5 | 5 | 5 | 5 |
| Stearic Acid | 1 | 1 | 1 | 1 | 1 | 1 |
| Antioxidant | 1 | 1 | 1 | 1 | 1 | 1 |
| 1,4-Butanediol | | 2 | 5 | 10 | 15 | 20 |
| Diacrylate | | | | | | |
| Dicumyl | 7.5 | 7.5 | 7.5 | 7.5 | 7.5 | 7.5 |
| peroxide | | | | | | |
| Delta Torque | 19.1 | 23.7 | 27.6 | 27.9 | 29.0 | 24.5 |
| (dNm) | | | | | | |
| Scorch Time | 1.42 | 0.65 | 0.64 | 0.53 | 0.42 | 0.54 |
| (minutes) | | | | | | |
| Tensile | 10.78 | 13.57 | 13.38 | 13.46 | 12.59 | 13.13 |
| Strength (MPa) | | | | | | |
| 100% Modulus | 1.51 | 2.58 | 3.10 | 3.60 | 3.72 | 4.02 |
| (MPa) | | | | | | |
| Compression | 24.3 | 14.5 | 12.9 | 13.3 | 12.6 | 14.7 |
| Set (%) | | | | | | |

### Examples 13-18 Comparative

The comparative examples 13-18 given in Table 4 utilize a second common monomeric coagent, trimethylolpropane triacrylate. This product also contains a proprietary scorch inhibitor. The compounds were prepared in a similar manner as outlined in the previous examples. At identical loadings, the monomeric triacrylate displays similar delta torque and tensile properties as previous examples. While scorch safety is improved relative to Examples 7-12, the scorch protection provided by the invention is greater.

TABLE 4

| | Examples | | | | | |
|---|---|---|---|---|---|---|
| Ingredient (phr) | 13 | 14 | 15 | 16 | 17 | 18 |
| EPDM | 100 | 100 | 100 | 100 | 100 | 100 |
| Carbon Black | 100 | 100 | 100 | 100 | 100 | 100 |
| Paraffinic Oil | 50 | 50 | 50 | 50 | 50 | 50 |
| Zinc Oxide | 5 | 5 | 5 | 5 | 5 | 5 |
| Stearic Acid | 1 | 1 | 1 | 1 | 1 | 1 |
| Antioxidant | 1 | 1 | 1 | 1 | 1 | 1 |
| Trimethylolpropane Triacrylate | | 2 | 5 | 10 | 15 | 20 |
| Dicumyl peroxide | 7.5 | 7.5 | 7.5 | 7.5 | 7.5 | 7.5 |
| Delta Torque (dNm) | 19.4 | 27.0 | 28.2 | 29.1 | 29.0 | 27.7 |
| Scorch Time (minutes) | 1.36 | 0.58 | 0.59 | 0.61 | 0.64 | 0.80 |
| Tensile Strength (MPa) | 8.76 | 12.42 | 12.73 | 12.44 | 12.22 | 11.66 |
| 100% Modulus (MPa) | 1.72 | 2.58 | 3.04 | 3.56 | 4.02 | 4.51 |
| Compression Set (%) | 24.2 | 15.2 | 11.4 | 11.2 | 11.0 | 10.5 |

### Examples 19-24 Comparative

The comparative examples 19-24 set forth in Table 5 utilize a polybutadiene resin coagent which contains no terminal acrylate functionality. The compounds were prepared in a similar manner as outlined in the previous examples. At identical loadings, the comparative unfunctional resin displays reduced delta torque and tensile properties and inferior compression set when compared to the examples of the invention, Examples 2-6. Although scorch protection is improved versus the invention examples, physical properties are more important and are improved in the invention examples.

TABLE 5

| | Examples | | | | | |
|---|---|---|---|---|---|---|
| Ingredient (phr) | 19 | 20 | 21 | 22 | 23 | 24 |
| EPDM | 100 | 100 | 100 | 100 | 100 | 100 |
| Carbon Black | 100 | 100 | 100 | 100 | 100 | 100 |
| Paraffinic Oil | 50 | 50 | 50 | 50 | 50 | 50 |
| Zinc Oxide | 5 | 5 | 5 | 5 | 5 | 5 |
| Stearic Acid | 1 | 1 | 1 | 1 | 1 | 1 |
| Antioxidant | 1 | 1 | 1 | 1 | 1 | 1 |
| Poly(butadiene), 3000 g/mol Mn | | 2 | 5 | 10 | 15 | 20 |
| Dicumyl peroxide | 7.5 | 7.5 | 7.5 | 7.5 | 7.5 | 7.5 |
| Delta Torque (dNm) | 17.1 | 20.4 | 22.0 | 22.5 | 23.1 | 20.6 |
| Scorch Time (minutes) | 1.42 | 1.29 | 1.41 | 1.53 | 1.73 | 1.72 |
| Tensile Strength (MPa) | 11.33 | 12.42 | 12.71 | 12.69 | 11.92 | 11.64 |
| 100% Modulus (MPa) | 1.86 | 2.27 | 2.47 | 2.63 | 2.72 | 2.47 |
| Compression Set (%) | 24.7 | 17.3 | 17.4 | 14.7 | 16.7 | 17.4 |

### Examples 25-30 Comparative

The comparative examples 25-30 utilize a blend of the monomeric diacrylate material evaluated in Examples 7-12 and an unfunctional polybutadiene resin. The binary blends were prepared such that the molar concentration of acrylate and vinyl groups is equivalent to that of the polybutadiene diacrylate in the invention Examples at a given phr. The molar concentration of acrylate functionality in the 1,4-butanediol diacrylate was calculated to be 10 mmol per gram monomer. The molar concentration of acrylate functionality in the polybutadiene diacrylate which embodies the invention contains 1 mmol per gram polymer resin. The coagent blends, identified as Blend A through E, are described in Table 6.

TABLE 6

| | 1,4-Butanediol Diacrylate | Poly(butadiene), 2000 g/mol Mn |
|---|---|---|
| Blend | (phr) | (phr) |
| A | 0.2 | 2.0 |
| B | 0.5 | 5.0 |
| C | 1.0 | 10.0 |
| D | 1.5 | 15.0 |
| E | 2.0 | 20.0 |

The compounds were prepared in a similar manner as outlined in the previous examples and the results of testing are provided in Table 7. Scorch protection and compression set similar to those given by the invention Examples. However, at identical loadings, the blends produce delta torque and modulus properties inferior to those obtained in invention Examples 2-6.

TABLE 7

| | Examples | | | | | |
|---|---|---|---|---|---|---|
| Ingredient (phr) | 25 | 26 | 27 | 28 | 29 | 30 |
| EPDM | 100 | 100 | 100 | 100 | 100 | 100 |
| Carbon Black | 100 | 100 | 100 | 100 | 100 | 100 |
| Paraffinic Oil | 50 | 50 | 50 | 50 | 50 | 50 |
| Zinc Oxide | 5 | 5 | 5 | 5 | 5 | 5 |
| Stearic Acid | 1 | 1 | 1 | 1 | 1 | 1 |
| Antioxidant | 1 | 1 | 1 | 1 | 1 | 1 |
| Blend A | | 2.2 | | | | |
| Blend B | | | 5.5 | | | |
| Blend C | | | | 11 | | |
| Blend D | | | | | 16.5 | |
| Blend E | | | | | | 22 |
| Dicumyl | 7.5 | 7.5 | 7.5 | 7.5 | 7.5 | 7.5 |
| peroxide | | | | | | |
| Delta Torque | 17.3 | 21.4 | 23.6 | 25.1 | 26.3 | 25.4 |
| (dNm) | | | | | | |
| Scorch Time | 1.63 | 1.05 | 1.09 | 1.02 | 1.00 | 1.13 |
| (minutes) | | | | | | |
| Tensile | 10.72 | 12.11 | 12.57 | 12.80 | 12.75 | 12.24 |
| Strength (MPa) | | | | | | |
| 100% Modulus | 1.53 | 1.87 | 2.02 | 2.43 | 2.49 | 2.64 |
| (MPa) | | | | | | |
| Compression | 26.1 | 16.0 | 10.2 | 12.7 | 10.3 | 10.6 |
| Set (%) | | | | | | |

While the invention has been described and exemplified in detail, various alternative embodiments and improvements should become apparent to those skilled in this art without departing from the spirit and scope of the invention.

What is claimed is:

1. A composition comprising by weight 100 parts of one or more elastomers; about 1 to 40 parts of one or more terminally-functional alkoxylated polybutadiene (meth)acrylate coagents; and optionally up to 200 parts by weight filler.

2. The composition of claim 1 wherein the terminally functional alkoxylated polybutadiene (meth)acrylates are of Formula I 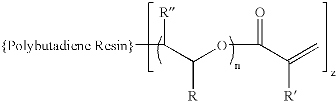
wherein
R is H, Me, Et or C₆H₅,
R″ is H or Me,
RΔ is H or Me,
n=1 to 100, and
Z=1 to 3.

3. The composition of claim 2, wherein the R′=H.

4. The composition of claim 1 wherein the one or more terminally-functional alkoxylated polybutadiene(meth)acrylates have a number average molecular weight Mn from 1000 to 12000.

5. The composition of claim 1, wherein the one or more terminally-functional alkoxylated polybutadiene(meth)acrylates contain at least 50% vinyl microstructure.

6. The composition of claim 1, wherein the one or more terminally-functional alkoxylated polybutadiene (meth)acrylates is present at 5 to 20 parts per 100 parts by weight of the said one or more elastomers.

7. The composition of claim 1, wherein the one or more elastomers are selected from the group of polydienes, copolymers of dienes and vinyl aromatic monomers, copolymers of dienes and acrylonitrile monomer, copolymers of ethylene and propylene, terpolymers of ethylene, propylene, and diene-containing monomers, hydrogenated forms of copolymers of dienes and acrylonitrile monomer, and hydrogenated forms of terpolymers of dienes, acrylonitrile monomers, and carboxylated monomers.

8. The composition of claim 1, wherein the said composition comprises as curing agent, at least one free-radical generating compound selected from peroxides, percarbonates or azo compounds.

9. The composition of claim 8, wherein the said free-radical producing peroxide generating compound is a peroxide selected from di-tertiary organic peroxides.

10. The composition of claim 9, wherein the said curing agent is a di-tertiary organic peroxide and is present in an amount of about 0.1 to 20 parts per 100 parts of the said one or more elastomers.

11. The composition of claim 1 further including from 1 to 200 parts of a filler material.

12. A method comprising adding from 1 to 40 parts of a coagent comprising at least one terminally-functional polybutadiene acrylate and/or methacrylate and a free radical generating curing agent to 100 parts of one or more elastomers and vulcanizing in the presence of a free radical generating compound.

13. A vulcanized rubber article prepared according to the method of claim 12.

14. The article of claim 13 in the form of a tire component, a rubber article for automotive and industrial applications, and an engineered rubber product selected from the group consisting of tire components, rubber articles for automotive and industrial applications, and engineered rubber products selected from belts, hoses, rubber gaskets, rings, engine mounts, vibration isolation mounts, and rubber rollers.
